(19) United States
(12) Patent Application Publication
(10) Pub. No.: US 2010/0009163 A1
(43) Pub. Date: Jan. 14, 2010

(54) METHOD FOR PRODUCING A BODY OF METAL-CERAMIC COMPOSITES

(76) Inventors: Gert Lindemann, Lichtenstein (DE); Matthias Leonhardt, Stuttgart (DE)

Correspondence Address: KENYON & KENYON LLP, ONE BROADWAY, NEW YORK, NY, 10004, US

(21) Appl. No.: 12/304,662

(22) PCT Filed: Sep. 11, 2007
(86) PCT No.: PCT/EP07/59516

§ 371 Date: May 21, 2009

(30) Foreign Application Priority Data
Oct. 30, 2006 (DE) 102006051200.6

(51) Int. Cl. B32B 3/26; C04B 35/64; C04B 35/653

(52) U.S. Cl. 428/320.2; 264/603; 264/332

(57) ABSTRACT

A method for producing a body of metal-ceramic composites, including the following steps of a) Producing a ceramic preform by sintering using a starting powder containing ceramic particles at an aspect ratio of 1-10, in such a way that the obtained preform has a porous structure with pore diameters of 0.5-10 μm and an overall porosity of 15-60% (sintering step), and b) Introducing molten metal of a pure metal or an alloy into the thus produced ceramic preform having a porous structure (infiltration step).

### FIELD OF THE INVENTION

The present invention relates to a method for producing a body of metal-ceramic composites.

### BACKGROUND INFORMATION

Brake calipers and other heavy-duty components, especially in the vehicle construction, are frequently made of cast iron with nodular graphite (GGG). The specifications regarding the rigidity of the component are satisfied by the relatively high module of elasticity of GGG (E_{GGG50}=170 GPa). However, the high density of cast iron, which results in components having a large mass, is disadvantageous.

In contrast, lightweight structural elements for the mentioned application cases are currently produced from, e.g., the aluminum alloy AlSi7Mg having a density of only 2.6 g/cm³. However, the low module of elasticity of the aluminum alloy (E_{AL}si7Mg=72 GPa) is a disadvantage with this material. The low module of elasticity of the material makes it necessary to produce especially stressed areas of the components, such as the bridge in the case of brake calipers, with greater thickness in the mentioned application cases. Nevertheless, these possibilities for realizing sufficient rigidity are often considerably limited by the available space.

A local reinforcement of the particularly stressed regions of the mentioned components with the aid of a material having a higher module of elasticity makes it possible to reduce the size, which results in greater design freedom for better utilization of the limited space.

In connection with brake calipers, an insert made from woven continuous Al₂O₃ fibers is discussed in WO 2004 018718, for example, the insert being infiltrated by AlCu₂ using gas pressure and provided with an Ni/Ag coating. The insert of composite material is then positioned in a mold in the bridge region, and the brake caliper made of an aluminum alloy is cast by squeeze casting.

U.S. Pat. No. 6,719,104 discusses the local reinforcement of lightweight brake calipers with the aid of inserts made from continuous Al₂O₃ fibers, steel or molybdenum.

U.S. Pat. No. 5,433,300 discloses the local reinforcement of lightweight brake calipers using inserts produced by a lost-foam process (negative casting of polyurethane foams).

All of these methods are quite complex and therefore very costly.

### SUMMARY OF THE INVENTION

Therefore, it is an object of the present invention to provide a method for local strengthening or reinforcement of lightweight structural components with the aid of inserts, which is less complex than the mentioned methods and additionally ensures a better connection between the insert and the lightweight structural component. This objective is achieved by the features described herein.

Accordingly, a method for producing a body of metal-ceramic composites is provided, the method having the following steps:

a) Producing a ceramic preform by sintering using a starting powder containing ceramic particles at an aspect ratio of 1-10, in such a way that the obtained preform has a porous structure with pore diameters of 0.5-10 μm and an overall porosity of 15-60% (sintering step); and

b) introducing molten metal of a pure metal or an alloy, which may be a light metal, into the thus produced ceramic preform having a porous structure (infiltration step).

The molten metal may be a light-metal alloy, especially an Al alloy. Especially preferred are curable Al alloys such as AlSi7Mg. The ceramic particles may be oxides, e.g., Al₂O₃, TiO₂, carbides, such as SiC, for example, or nitrides, such as Si₃N₄, AlN. Existing foreign atoms within the above meaning are, for instance, the Mg atoms in an AlSiMg alloy.

Porosity is to denote the ratio of the volume of all cavities of a porous solid body to its external volume. In other words, it is a measure for the space the actual solid matter is taking up within a specific volume or the cavities it leaves behind therein. The pores are generally filled with air. As a rule, the porosity of the perform therefore already specifies the ultimately to be expected volume components of the ceramic and the metal component of the composite.

The term aspect ratio should be understood to denote the length-width ratio of the employed ceramic particles. As already mentioned, the aspect ratio of the used ceramic particles may lie in the range of 1 to 10; that is to say, the particles may by all means have a longitudinal form. However, particles with such dimensions are not quite fibers yet. The aspect ratio may lie in the range of 1-5.

It is especially preferred if the pore diameter amounts to 1-5 μm, while the porosity may amount to 25-50%.

The metal-ceramic composites produced in this manner have low specific weight with high modules of elasticity on the one hand, and they are able to be intimately joined to the lightweight structural components to be reinforced on the other.

Furthermore, they may be produced quickly and inexpensively since, in contrast to methods of the related art, the component casting and infiltration of the insert preforms is carried out in one process step. Additional considerable cost savings result from the use of low-cost particles, which are very inexpensive in comparison with the extremely expensive ceramic fibers.

In addition, pore-forming material may be added to the starting powder containing ceramic particles. As a rule, these are longitudinal, easily combustible materials, which combust during sintering and thereby produce a network of channels and pores, which facilitates the subsequent infiltration of the molten metal and allows an intimate connection between the preform and the hardening metal. The channels produced in this manner may have widths of 2-50 μm which may be 5-30 μm. The metal channels filling the channels in the finished body increase the strength and toughness of the bodies.

The pore-forming materials—together with the set sintering parameters—exert a considerable influence on the adjustment of a specific porosity. However, pore-forming materials may also be used in the production of ceramic preforms, in particular, in order to produce a network of pore channels that results in better infiltrability of the preform; in this case, the pore channels function as infiltration channels. In addition, the metal channels obtained in this manner increase the stability and toughness of the material.

Especially preferred in this context is the use of cellulose platelets or fibers having a volume component of 1-30%, which may be 2-20%. In addition, soot particles, rice starch or organic macro molecules such as fullerenes or nanotubes, for instance, are also conceivable as pore-forming materials. Any materials that combust, disintegrate or gas out during sintering and in this manner produce cavities in the material are basically suitable as pore-forming material.

Furthermore, materials that release gas during sintering and thereby cause the formation of pores are likewise conceivable. In this context, NaHCO₃, which releases CO₂ under heat, would be an option.

Moreover, the present invention provides a body made of a metal-ceramic composite produced according to one of the preceding methods.

Furthermore, the present invention provides the use of a body of metal-ceramic composite produced according to one of the previous methods, as an insert for reinforcing lightweight structural components, especially in the manufacture of automobiles.

Disk brake calipers, in particular, count as light structural components, but also any other components produced from light metal and specifying locally high stability, especially in the construction of automobiles, motorcycles, airplanes and ships.

The material used for the lightweight structural components and the material used for the molten bath of the inserts may be largely identical. The term largely identical in the following text should be understood to indicate that the metals or alloys for the lightweight structural components and the inserts are each made from at least the same main components.

It is conceivable, for instance, to use AlSi7Mg for the lightweight structural component, and AlCu4MgSi for the insert. This means light-metal alloys, in particular, such as Al alloys. The selection of the largely identical materials allows an intimate connection between the lightweight structural component and the insert.

With the aid of the mentioned inserts, the mentioned lightweight structural components are able to be selectively reinforced in the regions of their highest stressing, while the weight and the dimensions of the lightweight structural components are simultaneously kept within narrow limits. In this way, lightweight components are able to be produced, which nevertheless have the highest modules of elasticity in the regions where this is required.

Furthermore, the present invention provides a method for introducing an insert made of metal-ceramic composites according to the present invention into a lightweight structural component. The method is characterized by a casting step being carried out simultaneously with or following the infiltration step, to produce the lightweight structural component. In the process, the insert is placed in the casting mold, and the lightweight structural component is then cast around the insert.

The surface of the metal-ceramic composite insert to be cast should be modified in such a way that the connection of the lightweight-structural component recast is improved. This may be achieved by mechanical surface processing such as roughening, or by applying a coating (e.g., Zn, AlSi12, Cu, NiCrAl, NiAg). The coating may be applied by flame-spraying, galvanically or in a currentless manner.

The material used for the lightweight structural components and the material used for the molten bath of the inserts may be largely identical. Light-metal alloys, such as Al alloys, are conceivable here, in particular. The selection of the largely identical materials allows an intimate connection between the lightweight structural component and the insert.

In this case, the casting method need not necessarily be a casting method that uses pressure.

In one especially specific embodiment, the infiltration step and casting step are combined into one process step, in such a way that the preform together with the cast of the lightweight structural component is infiltrated under pressure.

This method is also referred to as integrated preform infiltration. Casting processes, which generally must be carried out under pressure in order to be able to achieve a metal infiltration of the ceramic perform, are used in this context. A pressurized introduction of the molten metal into the casting mold is especially preferred (squeeze casting). In this method, an integrated preform infiltration without pressure would hardly be possible with most metal-ceramic combinations because of the poor wetting characteristics between metal and ceramic.

This method achieves an intimate connection between the lightweight structural component and the insert. The latter is possible in particular by implementing the infiltration of the preform to produce the insert introduced into the component, and the casting of the surrounding component in one step using casting processes carried out under pressure. This results in an excellent interfacial surface connection between insert and component recast.

It is especially preferred if the ceramic preform is positioned in the casting mold at the location to be reinforced. In this way the insert can already be situated in the correct position and location in the mold of the lightweight structural component to be produced. This reduces the production cost and shortens the production time, and it simultaneously allows a precise placement of the insert in the lightweight structural component as well as an especially intimate connection between the lightweight structural component and the insert.

If the metal alloy is a curable alloy, as in the case of lightweight sliding calipers, for example, then the casting step may be followed by the curing step:

Curing of the lightweight structural component by rapid cooling at a cooling rate that is sufficiently high to ensure a metastable supersaturation of possibly present foreign atoms in the used alloy, and sufficiently low to prevent damage to the insert made of metal-ceramic composite due to thermoshock (curing step).

Usable as cooling media are air at room temperature, silicone oil or mineral oils, for example.

### EXAMPLES

The present invention is explained in greater detail with the aid of the examples discussed in the following text. It should be noted that the figures have only descriptive character and are not intended to restrict the present invention in any form.

1. Production of Metal-Ceramic Composites

Using the method according to the present invention, it was possible to produce aluminum-based metal-ceramic composites whose ceramic content amounted to up to 70 vol. %. The ceramic component consisted of Al₂O₃ particles at an aspect ratio of 1 to 5, while the metal component consisted of AlSi7Mg. The experimentally determined modules of elasticity in these materials were considerably above 200 GPa.

Using a sliding caliper as example, a reinforcement effect of at least 20% could be demonstrated in simulations as a result of the introduction of such reinforcement elements in the bridge region.

A module of elasticity of 242 GPa was determined in metal-ceramic composites made up of 70 vol. % of Al₂O₃ and 30 vol. % AlSi7Mg after curing (cooling medium. silicone oil).

2. Production of a Sliding Caliper Including an Insert

Furthermore, aluminum sliding calipers in real geometry were cast using a serial squeeze cast machine, geometrically adapted preforms made of TiO₂— und Al₂O₃ particles with a porosity of >55 vol.-% having been positioned in the bridge region and infiltrated by AlSi7Mg molten metal during the casting process. The inserts were able to be completely infiltrated in the process. The quality of the connection between insert and recast was determined by measuring the interface shearing resistance and was even above the shearing resistance of the pure alloy (107 MPa vs. 101 MPa) due to meshing effects. An excellent connection of the insert is therefore ensured by the utilized materials and the afore-described production process.

1-10. (canceled)

11. A method for producing a body of metal-ceramic composites, the method comprising:
a) producing a ceramic preform by sintering using a starting powder containing ceramic particles at an aspect ratio of 1-10, so that an obtained preform has a porous structure with pore diameters of 0.5-10 μm and an overall porosity of 15-60%, in the sintering; and
b) introducing molten metal of pure metal or an alloy into the thus produced ceramic preform having a porous structure, in an infiltration.

12. The method of claim 11, wherein at least one of (i) the molten metal is at least one of a light metal alloy and an Al alloy, and (ii) the ceramic particles are at least one of oxides, nitrides and carbides.

13. The method of claim 11, wherein a pore-forming material is added to the starting powder containing ceramic particles.

14. A body made of a metal-ceramic composite, comprising:
a ceramic preform, made by sintering using a starting powder containing ceramic particles at an aspect ratio of 1-10, so that an obtained preform has a porous structure with pore diameters of 0.5-10 μm and an overall porosity of 15-60%, in the sintering; and
a metal of pure metal or an alloy in the ceramic preform having a porous structure, in an infiltration.

15. A body made of a metal-ceramic composite, comprising:
a ceramic preform, made by sintering using a starting powder containing ceramic particles at an aspect ratio of 1-10, so that an obtained preform has a porous structure with pore diameters of 0.5-10 μm and an overall porosity of 15-60%, in the sintering; and
a metal of pure metal or an alloy in the ceramic preform having a porous structure, in an infiltration;
wherein the body is used to reinforce lightweight structural components in the manufacture of an automobile.

16. A method for introducing an insert of metal-ceramic composites into a lightweight structural component, the method comprising:
producing a body of metal-ceramic composites, by a) producing a ceramic preform by sintering using a starting powder containing ceramic particles at an aspect ratio of 1-10, so that an obtained preform has a porous structure with pore diameters of 0.5-10 μm and an overall porosity of 15-60%, in the sintering, and b) introducing molten metal of pure metal or an alloy into the thus produced ceramic preform having a porous structure, in an infiltration; and
using a casting to produce the lightweight structural component simultaneously with or following the infiltration.

17. The method of claim 16, wherein a surface of the insert of metal-ceramic composite to be cast around is modified so that the connection of the lightweight-structural component-recast is improved.

18. The method of claim 16, wherein the infiltration and the casting are combined into one process step so that the preform together with the cast of the lightweight structural component is infiltrated under pressure.

19. The method of claim 16, wherein the ceramic preform is positioned in the casting mold at the location to be reinforced.

20. The method of claim 16, wherein the casting is followed by curing of the lightweight structural component by rapid cooling at a cooling rate that is sufficiently high to ensure a meta-stable supersaturation of possibly present foreign atoms in the used alloy, and sufficiently low to prevent damage to the insert of metal-ceramic composite by thermoshock, in the curing.
